(19) United States
(12) Patent Application Publication
(10) Pub. No.: US 2025/0117858 A1
(43) Pub. Date: Apr. 10, 2025

(54) CLIMATE RISK ASSESSMENT SYSTEM AND METHOD FOR CLIMATE CHANGE MITIGATION

(71) Applicant: Allstate Insurance Company, Northbrook, IL (US)

(72) Inventors: Andrew Young, Livingston, NJ (US); Marvin Lu, Chicago, IL (US); Sarah K. Webster, Wilmington, NC (US)

(21) Appl. No.: 18/377,403

(22) Filed: Oct. 6, 2023

(51) Int. Cl. G06Q 40/08; G06N 3/0455; G06N 3/09; G06Q 10/0631; G06Q 50/16

(52) U.S. Cl. CPC G06Q 40/08; G06N 3/0455; G06N 3/09; G06Q 10/063118; G06Q 50/163

(57) ABSTRACT

Disclosed are systems, apparatuses, methods, and computer readable medium for a climate risk assessment system. A disclosed climate risk assessment system can include a machine learning (ML) model or other neural network that is capable of understanding unstructured data to build loss models that can estimate effects of climate change and risks associated with building based on the effects of climate change. A method of the climate risk assessment system includes: receiving an unstructured document; identifying a property associated with the document based on geographical information extracted from the unstructured document; identifying at least one modified building property associated the unstructured document; updating a data structure corresponding to the building to include the at least one modified building property; and updating a loss model associated with the property based on the data structure.

### TECHNICAL FIELD

The present disclosure generally relates to climate risk assessment systems. In some examples, aspects of the present disclosure are related to a climate risk assessment system and methods for optimizing property to mitigate climate risks.

### BACKGROUND

Climate change results in various new and evolving risks to businesses, homes, and homeowners, such as the increased risk for wildfires, flooding, increasingly powerful and violent storms, rising sea level and the degradation of coastal land, extreme weather events, and other climate-related risks and catastrophes. These climate-related risks may take homeowners by surprise, as the risks they experienced in historical climate patterns will no longer be an accurate predictor of the future risk to their homes and other property. Homeowners will need assistance with understanding climate risks as applied to their personal property, such as the evolving risks they will face, understanding government requirements (e.g., building codes for their area), and understanding available solutions and options for mitigating the risk to their property.

It is with these observations in mind, among others, that aspects of the present disclosure were conceived and developed.

### SUMMARY

In some examples, systems, and techniques are described for climate change mitigation and climate risk assessment system. The systems and techniques can provide visibility into property and other infrastructure to allow active improvement to harden against climate risks.

According to at least one example, a method is provided for mitigating climate change risk. The method includes: receiving an unstructured document; identifying a property associated with the document based on geographical information extracted from the unstructured document; identifying at least one modified building property associated the unstructured document; updating a data structure corresponding to the property to include the at least one modified building property; and updating a loss model associated with the property based on the data structure.

In another example, an apparatus for mitigating climate change risk is provided that includes at least one memory and at least one processor coupled to the at least one memory. The at least one processor is configured to: receive an unstructured document; identify a property associated with the document based on geographical information extracted from the unstructured document; identify at least one modified building property associated the unstructured document; update a data structure corresponding to the property to include the at least one modified building property; and update a loss model associated with the property based on the data structure.

In another example, a non-transitory computer-readable medium is provided that has stored thereon instructions that, when executed by one or more processors, cause the one or more processors to: receiving an unstructured document; identify a property associated with the document based on geographical information extracted from the unstructured document; identify at least one modified building property associated the unstructured document; update a data structure corresponding to the property to include the at least one modified building property; and update a loss model associated with the property based on the data structure.

In another example, an apparatus for mitigating climate change risk is provided. The apparatus includes: receiving an unstructured document; means for identifying a property associated with the document based on geographical information extracted from the unstructured document; means for identifying at least one modified building property associated the unstructured document; means for updating a data structure corresponding to the property to include the at least one modified building property; and means for updating a loss model associated with the property based on the data structure.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is a conceptual diagram illustrating a method for assessing and improving property based on climate risk assessment in accordance with some aspects of the disclosure;

FIG. 2 is a block diagram of a climate risk assessment system 200 in accordance with some aspects of the disclosure;

FIG. 3 illustrates an example timeline of a generating a dataset and an error model of the building in accordance with some aspects of the disclosure;

FIG. 4 is an illustration of macro-climate risks that may be applied in some aspects of the disclosure;

FIGS. 5A and 5B illustrate examples of micro-climate risk mitigation based on different climate risks in accordance with some aspects of the disclosure;

FIG. 6 illustrates an example method of a climate risk assessment system in accordance with some aspects of the disclosure;

FIG. 7 is a block diagram of an example transformer in accordance with some aspects of the disclosure;

FIG. 8 is a block diagram of various encoders that can be used to identify features of unstructured documents in accordance with some aspects of the disclosure;

FIG. 9 is a block diagram of various classifiers that can be used to identify one or more classifications from one or more taxonomies in accordance with some aspects of the disclosure;

FIG. 10 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Climate change poses significant challenges to the insurance industry, leading to a growing number of problems in terms of coverage, pricing, and risk assessment. Various issues exist, such as an increasing frequency and severity of natural disasters (e.g., hurricanes, floods, and wildfires) that are increasing business risks to insurance companies. These extreme weather events are causing widespread property damage and losses, resulting in higher claims payouts. Insurers are struggling to accurately predict and price these risks, leading to higher premiums for policyholders or even withdrawal of coverage altogether in some high-risk areas. This has the potential to leave individuals and businesses vulnerable to climate-related damage.

Climate change also poses significant challenges for homeowners in areas that are not deemed high-risk. Previous construction standards may be outdated due to increased risk from elevated rainfall estimates due to higher humidity caused by higher temperatures. A lifespan of a roof may be decreased due to higher rainfall estimates and more moisture in the ground can affect the health of the building.

Long-term impacts of climate change, such as rising sea levels and changing weather patterns, are leading to uncertain future risks. Insurers heavily rely on historical data to assess risk, but the changing climate introduces new variables that challenge traditional actuarial models. This uncertainty makes it difficult for insurers to accurately estimate future damages and losses, which can result in underpricing or inadequate coverage. Additionally, climate-related risks can extend beyond traditional property insurance, affecting sectors like agriculture and health, where insurers may struggle to adapt their products and services to new and emerging risks.

The volatility of the climate due to climate change is also affecting the availability and affordability of insurance coverage. In areas prone to climate-related risks, insurers are becoming more cautious and selective about offering coverage, leading to reduced options for consumers. This is particularly concerning for individuals and businesses located in high-risk areas, as they may find it increasingly challenging to obtain affordable coverage or face coverage exclusions for climate-related perils. The insurance industry is grappling with the need to balance the financial viability of their business with the societal implications of climate change, making it essential to develop innovative solutions and collaborative efforts to address these insurance problems in the face of a changing climate.

Disclosed herein are systems, methods, and computer-readable storage media for climate assessment and improvement for policyholders. In some aspects, the approaches herein can use various unstructured information and various hardening techniques to identify changes to property (e.g., buildings and landscape) based on climate change and identify educational opportunities to assist policyholders to harden property and buildings to mitigate the effects of climate change. The disclosure addresses the identified challenges with a combination of improved data and modeling techniques, innovative risk management strategies, and collaborative efforts among insurers, policymakers, and other stakeholders to allow insurers to provide resilient and adaptive insurance solutions that can effectively respond to the evolving risks associated with climate change.

A disclosed climate risk assessment system can include a machine learning (ML) model or other artificial intelligence (AI) network that is capable of understanding unstructured data to build loss models that can estimate the effects of climate change and risks associated with building based on the effects of climate change. In some aspects, the climate risk assessment system can transform data in different domains (e.g., text, images) for complex analysis to train ML models. In one illustrative example, the ML model may be configured to generate an error model associated with one or more properties (e.g., building). In other cases, the ML model may also be configured to generate an insurance model that identifies potential issues and a supervised process may be performed to enable an agent to assess insurance policies and premiums. In yet another case, the ML model can also identify regions of extreme risk and identify these regions as uninsurable, which can be used by a real estate developer to minimize development risks.

A disclosed climate risk assessment system can also update loss models based on preventative improvements. An example method includes receiving an unstructured document and identifying a building associated with the document based on geographical information extracted from the unstructured document. In response to identifying the building, the disclosed system can retrieve a loss model associated with the building, as well as potential data (e.g., cold storage data in a data lake), and then identify at least one modified building property associated with the unstructured document. For example, the at least one modified building property may be enhancements to a roof to secure the roof from potential damage during high wind events (e.g., a hurricane). Based on the modified building property, the climate risk assessment system may update a data structure corresponding to the property (e.g., a building on a property) to include the at least one modified building property and update a loss model associated with the building based on the data structure. The loss model can be used to determine various information, such as an insurance cost of a policyholder, premiums, policy rate increases, etc. In some cases, the insurer may provide incentives to encourage policyholders to proactively apply different improvements based on a data model that corresponds to the building and harden the property to reduce climate change effects.

Additional details and aspects of the present disclosure are described in more detail below with respect to the figures.

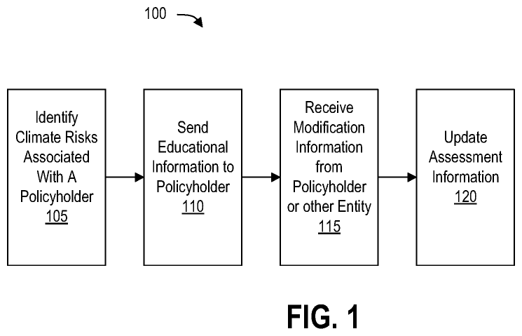

FIG. 1 is a conceptual diagram illustrating a method for assessing and improving property based on climate risk assessment in accordance with some aspects of the disclosure.

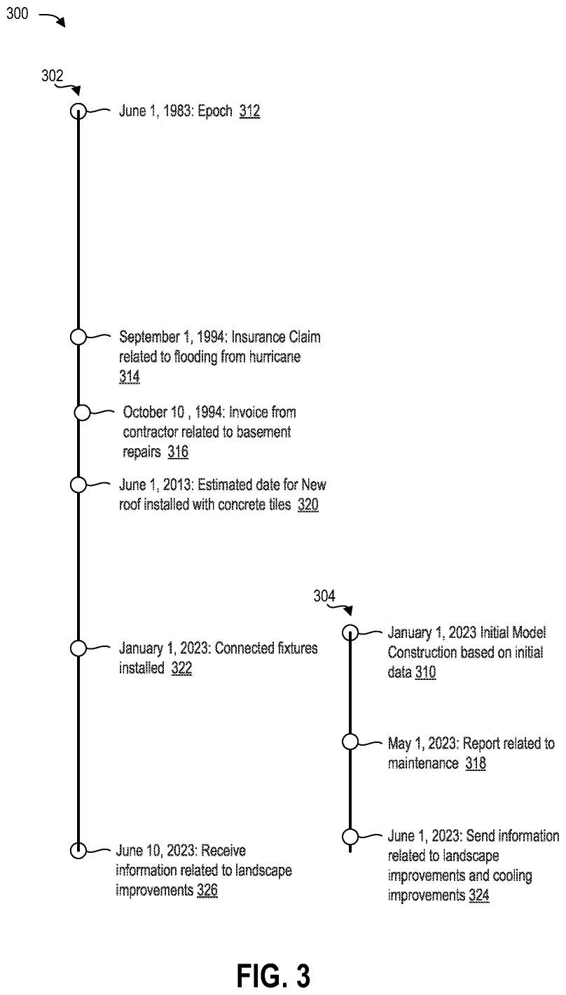

In some aspects, the method illustrates an overview method 100 that can be used to assist with the development of a dataset related to buildings, homes, fixtures, and other real estate structures associated with a property (herein, referred to as a building for purposes of clarity). In some aspects, the method 100 begins under the presumption that a fully qualified dataset is constructed, which will be described below with reference to FIG. 3. Initially, a climate risk assessment system (not shown) may use various information to actively identify climate risks associated with a policyholder at block 105. This step can occur automatically, in response to various events (e.g., an insurance claim), or on an interval. In one illustrative example, the climate risk assessment system may perform the

At block 110, the climate risk assessment system may send educational information to policyholders related to updates that may mitigate against climate-based changes. As an example, climate change increases the moisture content of the ground due to more intense rainfalls, and the climate risk assessment system may identify that a vapor barrier or other humidity-blocking structure is not installed, which can cause humidity to enter the walls of a building. In this case, the climate risk assessment system may send information indicating that a moisture barrier should be installed and can recommend several different vendors that are known to the insurance entity and are trusted.

At block 115, the climate risk assessment system may receive modification information from the policyholder or another entity. For example, the policyholder may contract out to add the improvement identified in the update in block 110. In this case, the policyholder may submit a forward claim that identifies the improvement, the reason for the improvement, and information supporting the improvement (e.g., images of an installed water barrier, images of a roof modification, etc.). In other cases, a contracting party can provide the information to the insurance entity (e.g., a vendor that is recommended by the insurance entity in block 110).

At block 120, the climate risk assessment system may update information pertaining to the building. For example, each building may be configured with a loss model based on a combination of known geographical information, satellite information, prior insurance claims, real estate information, regulatory information, and so forth. In this case, the loss model can be updated based on the updated information. In other aspects, the climate risk assessment system may update a security disbursement requirement of the policyholder to maintain insurance coverage. In this case, the loss model of the building is improved and therefore mitigates climate changes to reduce the security that the policyholder must submit to cover the building.

Further details of the climate risk assessment system are further described below and describe various operations pertaining to incorporating structured and unstructured data. The processing of the unstructured input is a transformation that changes the use of the data into embeddings that represent a feature. Unstructured content is any content with text that lacks a predefined format or organization and may include a variety of information, such as sentences, paragraphs, bullet points, headings, images, tables, and hyperlinks, arranged in a non-linear or free-form way. Unstructured content can be found in various contexts, such as emails, papers, grants, reports, insurance claims, specifications (e.g., a hardening specification), social media posts, web pages, legal contracts, research papers, or customer reviews. Unstructured content can also be semi-structured content, such as extensible markup language (XML) without a formal schema that identifies relationships, or JavaScript object notation (JSON) that identifies hierarchical information in text format. Non-limiting examples of unstructured content input into the climate risk assessment system include trade information (e.g., information from a trade association such as a recommendation or a standard), real estate information (e.g., building information available from various public and private sources such as multiple listing service (MLS), etc.), regulatory information (e.g., permits and other information related to improvements from a regulatory agency), claim information (e.g., insurance claims provided over the course of a building's life), invoices (e.g., a vendor's invoice related to a repair), reports (e.g., a home inspection report), and so forth.

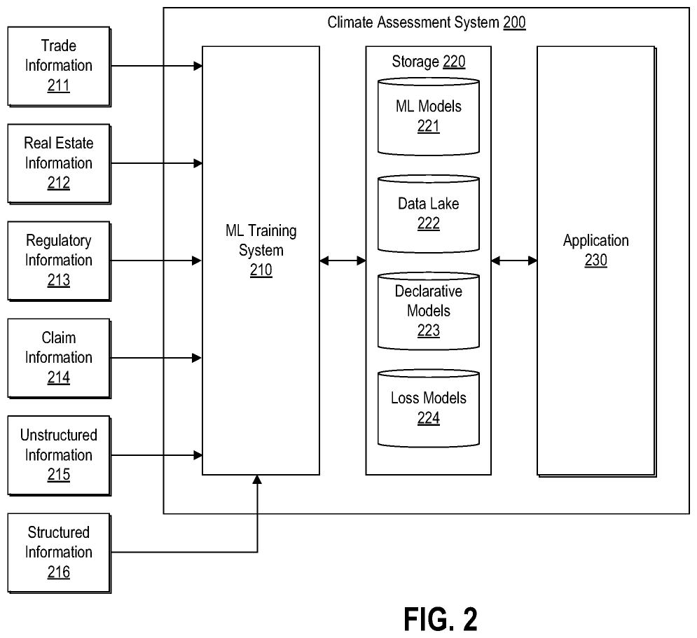

FIG. 2 is a block diagram of a climate risk assessment system 200 in accordance with some aspects of the disclosure. In some aspects, the climate risk assessment system 200 includes an ML training system 210, a storage system 220, and one or more applications 230. The ML training system 210 is configured to receive various information, such as trade information 211, real estate information 212, regulatory information 213, claim information 214, other unstructured information 215, and various structured information 216.

The trade information 211 comprises various information from trade associations and other interested groups related to building construction, maintenance, energy, and hardening (e.g., the National Association of Home Builders (NAHB), Building Trades Employers Association (BTEA), International Code Council (ICC), etc.). The trade information 211 can include various standards, recommendations, and other content that can be used to identify improvements and modifications to mitigate climate change effects in a particular geolocation. In some cases, the trade information 211 can be used in connection with the supervised training of an ML model.

The real estate information 212 can include various features related to one or more buildings that can the ML training system 210 can train and estimate the damage and other loss. For example, MLS information can identify various features that could increase risk (e.g., a hot tub) or decrease risk (a type of roof, pictures that illustrate non-combustible landscaping features, etc.). The regulatory information 213 comprises information from a government agency, such as an agency related to licensing and approving updates and modifications to a building. For example, an agency can approve modifications to existing infrastructure, such as the deployment of superior electrical wiring and panels and reduce electrical risk.

In some aspects, the claim information 214 may be information already possessed by a party or can be provided by another related party, that is related to lifecycle information of a building. Non-limiting examples of claim information 214 include information possessed by an insurer related to a property, information retrieved from another insurer, information received by a policyholder pertaining to the building lifecycle (e.g., a list of receipts identifying various improvements, etc.), and so forth.

Other unstructured information 215 can be provided by various parties. For example, a home inspection agency may report the results of home inspections to an insurer as part of an agreement. In other cases, the insurer may require a potential policyholder to provide the home inspection report in connection with an application process. In other cases, the unstructured information 215 can also be reports from other services, such as a plumber, an electrician, etc.

In some cases, the climate risk assessment system 200 may also receive various structured information 216. In some aspects, the climate risk assessment system 200 may receive information from a third-party that is structured and cleaned to remove irrelevant information. For example, a home facts dataset may be offered by a third party and the climate risk assessment system 200 can facilitate ML training based on the home facts dataset. In some cases, the structured information can include various objective information, such as a topographical map identifying altitude information of a geography, satellite information identifying terrain and various terrain features (e.g., combustible land features, etc.).

In some cases, the various data sources above may be cleaned using a semi-supervised process or a supervised process. For example, an ML model can be configured to extract information into a structured form or a form with embeddings, and a person can review and modify the extracted information to provide a high-quality dataset for training, evaluation, and/or validation. The training dataset is used to train the ML model, the evaluation dataset is used as a benchmark to identify the quality of the training, and the evaluation dataset is a final benchmark that determines the loss of the ML model.

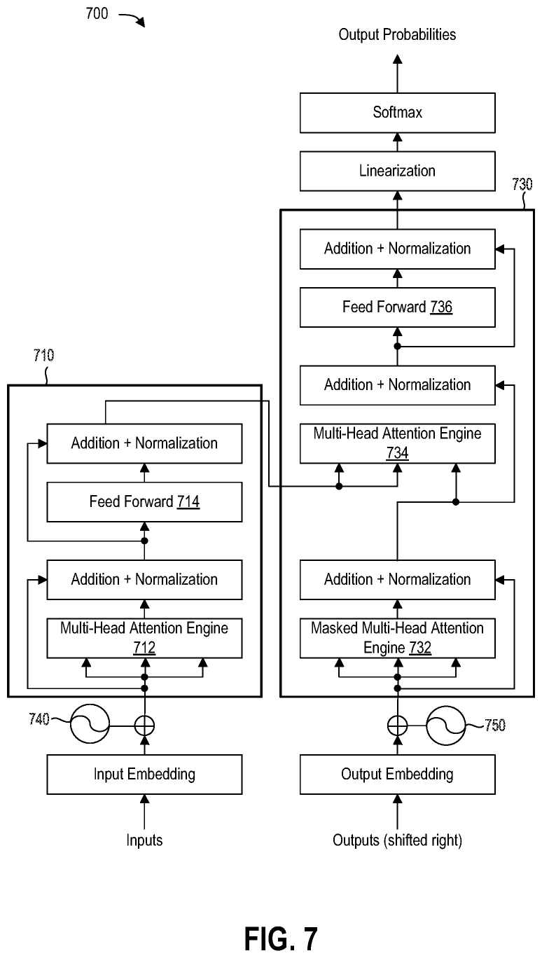

In some aspects, the ML training system 210 is configured to receive the information and process the information into different content and store the content in the storage system 220. The ML training system 210 can generate a plurality of ML models 221 associated with different functions of the climate risk assessment system 200. For example, the ML models 221 can include classifiers to classify a modification to a building, a transformer to understand the relationships of works in unstructured information (e.g., the transformer 700 of FIG. 7), and so forth. A non-limiting and illustrative example of ML model is a climate risk assessment model that is configured to receive different types of unstructured information, embeddings, structured content (e.g., maps, etc.), and assess a risk of damage to the building based on geographical information (e.g., terrain, etc.) and climate risk factors (e.g., humidity, rainfall, geography, etc.).

In some aspects, a transformer model includes a multi-layer encoder-decoder architecture. The encoder takes the input text and converts the input text into a sequence of hidden representations and captures the meaning of the text at different levels of abstraction. The decoder then uses these representations to generate an output sequence, such as a text translation or a summary. The encoder and decoder are trained together using a combination of supervised and unsupervised learning techniques, such as maximum likelihood estimation and self-supervised pretraining. Illustrative examples of transformer engines include a Bidirectional Encoder Representations from Transformers (BERT) model, a Text-to-Text Transfer Transformer (T5), biomedical BERT (BioBERT), scientific BERT (SciBERT), and the SPECTER model for document-level representation learning. In some aspects, multiple transformer engines may be used to generate different embeddings.

An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning and natural language processing tasks, such as language modeling, sentiment analysis, and machine translation. Embeddings are typically learned from large corpora of data using unsupervised learning algorithms, such as word2vec, GloVe, or fastText, which optimize the embeddings based on the co-occurrence or context of the objects in the data. Once learned, embeddings can be used to improve the performance of downstream tasks by providing a more meaningful and compact representation of the objects, irrespective of the source of that object (e.g., images, text, etc.). In some cases, embeddings associated with different ML models (e.g., classifiers, etc.) can be combined based on different techniques.

The ML training system 210 can also be configured to store one or more information within a data lake for later retrieval. For example, the ML training system 210 may store processed information from the trade information 211, the real estate information 212, the regulatory information 213, and the claim information 214. As an example, the claims associated with the property may be stored in the data lake 222. In some aspects, the storage system 220 can also store one or more declarative models 223, which are rule-based models for identifying or deducing information. Declarative models 223 can be provided from various sources, for example, the ML training system 210 can include a module configured to generate a declarative model based on the structured information 216.

In some cases, the ML training system 210 is also configured to generate a loss model 224 associated with a building. In some cases, the ML training system 210 can be invoked based on information retrieved from an external party (e.g., a vendor who performs a preventative repair on a roof) and the ML training system 210 may be configured to execute a module to generate the loss model 224 associated with the building. In this case, updates to buildings can be individually modeled and forecasted without requiring a simulation of an entire region.

In some cases, the storage system 220 can use a distributed, immutable data structure that can only be modified based on a one-way binding for some data. An immutable data structure including the one-way binding cannot be modified but can be appended to. For example, the immutable data structure can be facts pertaining to a property, such as initial construction and each appended item of data can correspond to a change within the property. In this way, the immutable data structure can represent a full history of the property and various information pertaining to the property can be surfaced. For example, a construction date of the property can reveal that aspects of the property are more combustible, and minor improvements can address these combustible materials. In some cases, records of the immutable property (e.g., data that represents a fact associated with the property) can be protected by a cryptographic hash to prevent alteration of the immutable data structure. In some cases, the immutable data structure can be distributed to ensure that the data cannot be lost.

The climate risk assessment system 200 can also include various applications 230 that use the various ML models 221, data lake 222, the declarative models 223, and the loss model 224 for various functions. In some aspects, an application can be configured to use the various information to generate an estimate to insure one or more buildings. In another aspect, the application may be related to insurance requirements and is configured to identify whether to offer insurance products within a specific geographic region. In this case, the application can identify potential improvements that can be mandated by the municipality that, if required, would allow the insurer to provide a level of support. In another case, an application 230 may be configured to receive information related to various components of a building, such as information from a modern, connected appliance that monitors and controls the environment. For example, an air register with a sensor that detects airborne particles can identify various factors associated with the house. A thermostat can identify temperature, and based on power consumption, the application may be able to identify potential mitigation remedies.

Other implementations of applications 230 can also be created, and may have varying scopes and use different models, data sets, etc. In one example, the application may be a client-facing application that enables a user to perform hypothetical improvements to identify changes that would provide better protection for the user. The climate risk assessment system 200 provides various incentives for policyholders and potential policyholders to be proactive regarding maintenance and improvements to minimize risks of climate change and can enable facilitate insurers to make better decisions to enable property owners to reduce risk and focus on core tasks.

FIG. 3 illustrates an example timeline of generating a dataset and an error model of the building in accordance with some aspects of the disclosure. In one example, a timeline 302 is associated with a building lifecycle (e.g., construction, modification, etc.) based on the execution of an application (e.g., the application 230 of FIG. 2). In some aspects, a timeline 304 of the application illustrates that, at block 310, a climate risk assessment system constructs an initial model based on initial data. For example, as noted above, the climate risk assessment system can use various information such as agency information, real estate information, etc. to identify events of the property that have occurred over a period of time. For example, the climate risk assessment system can identify an epoch of the building at block 312, and the epoch can provide various information such as estimated construction date, estimated materials based on the estimated construction date, and use various known standards at the time of construction to infer necessary information. In some cases, information from other reports (e.g., a permit to modify the building) can be used to infer various facts about the building, such as support members, roof materials, etc.

In one example, unstructured information can be identified from a prior insurance claim at block 314, which identifies an insurance claim related to flooding of the building. In this case, the flooding may have been associated with a basement, and the epoch at block 312 can inferentially be configured to identify that the initial construction included a basement. In some cases, this inference can be useful to identify potential issues based on past standards that have been updated since the epoch. At block 316, the climate risk assessment system may identify an invoice from a contractor related to the flooding, and the climate risk assessment system infers that, for example, a pump is installed in the basement.

At block 318, after the initial model construction, the climate risk assessment system may receive a report related to the maintenance of the building. In this case, the climate risk assessment system may identify conflicting information because roof materials identified in the report (e.g., concrete tiles) are different from materials identified in the epoch. In this case, the climate risk assessment system can estimate a date that the new roof at block 320, and the climate risk assessment system can also infer other information about construction materials associated with the epoch because the structural requirements for concrete tiles are higher than wood shingles.

In some aspects, at block 322, the climate risk assessment system may also detect that at least one connected fixture was installed in the building based on information provided to the climate risk assessment system or provided by a connected fixture manufacturer. As an example, a sensor is configured for monitoring and controlling heating and cooling and may include one or more sensors for detecting particles in the air.

In some aspects, at block 324, the climate risk assessment system may also perform various functions in response to receiving additional data for ingestion and storage. As an example, the climate risk assessment system may receive satellite information from a third-party service and the climate risk assessment system may identify that landscape features increase fire risk. In this case, the climate risk assessment system may also identify that the cooling system is operating with less efficiency. The climate risk assessment system sends information to a policyholder with information related to landscape and cooling improvements that can reduce fire risk and improve cooling efficiency and provide an incentive to make at least the improvements that reduce climate change issues.

At block 326, the climate risk assessment system receives information (e.g., from a vendor or contractor) that identifies various changes made to the landscaping. In some cases, the information can be provided by the policyholder and the climate risk assessment system may perform validation on the information from the policyholder and/or from an external source. As an example, the climate risk assessment system sends a notice to trim a tree line and various modifications to improve fire resistance. In response to images and other information received from a policyholder, the climate risk assessment system may validate the modifications based on the images. In another case, the climate risk assessment system can request satellite imagery from a third-party service to validate the fire resistance changes. In response to the changes, the climate risk assessment system then can apply an incentive.

In some cases, the incentive may be a premium reduction based on the significance of the change. For example, relocating a house on a beach inland can reduce costs for a period of time. In other cases, the incentive can be a rate lock or a guaranteed rate for a period of time to encourage incremental, persistent changes to the building.

The climate risk assessment system is configured to generate a loss model associated with the building based on potential modifications, identification of additional risks, and other factors. The loss model is configured to identify potential losses in the event of different scenarios, such as a hurricane after severe rain, severe rain after a drought, etc. An input into the loss model can be various weather patterns, such as an estimated weather pattern for a year, and the output of the loss model can identify damage to the building. Based on the loss model, an insurer can determine whether to insure and a corresponding price that provides suitable coverage to the policyholder, but also balances protection of the insurer. To this end, the climate risk assessment system may reduce the risk for an insurer and allows increased coverage by improving forecasts.

As described in FIG. 3, the climate risk assessment system may regenerate a loss model for a building in response to a modification. The climate risk assessment system may include a loss generation model that is trained to generate iterative models based on federated learning techniques and, as buildings within a geographical region are modified, the loss generation model can update loss models.

In other cases, the climate risk assessment system may also be trained based on an initial data set that comprises a variety to input, as described above with reference to FIG. 1. The climate risk assessment system may also use various learning techniques and data to improve the initial and further (e.g., federated) learning. For example, the climate risk assessment system may implement reinforced learning techniques based on a declarative, rule-based logic that assists the climate risk assessment system in tuning hyperparameters. The initial data can be generated based on a complex process that synthesizes the various information from different sources (e.g., agency, media, weather information, claims data, etc.) to generate an ML model for estimating loss. In some cases, the ML model can estimate the loss or may construct another model associated with loss based on various input information. For example, the constructed model can be an input into an application that can estimate damage due to various environmental effects.

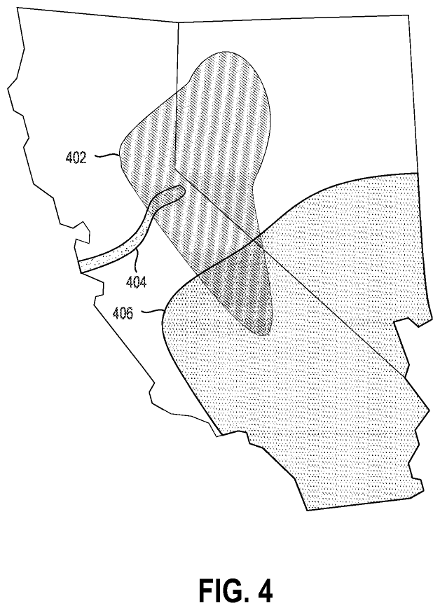

FIG. 4 is an illustration of macro-climate risks that may be applied in some aspects of the disclosure. A macro-climate risk is a generalization that can be applied to a particular region based on cumulative issues within a region, such as an area that is prone to wildfires, floods, mudslides, hurricanes, tornados, etc. For example, a wildfire region 402 may be associated with a large number of wildfires, as well as known activity that is likely to cause a wildfire based on irresponsible behavior. In this case, even if a building is built with fire-retardant materials in the wildfire region 402, it is not possible to guarantee insulation from wildfire, or heat generated due to wildfire. In this case, an ML model can identify the wildfire region 402 based on training data, which can be used as a multiplier to model risk and loss.

Macro-climate risks can be associated with different aspects, for example, a flood region 404 can be associated with a river due to increased hydration due to atmospheric rivers. In other cases, an arid zone 406 can be associated with reduced precipitation and can be associated with increased mudslides, lack of groundwater, another other climate risks.

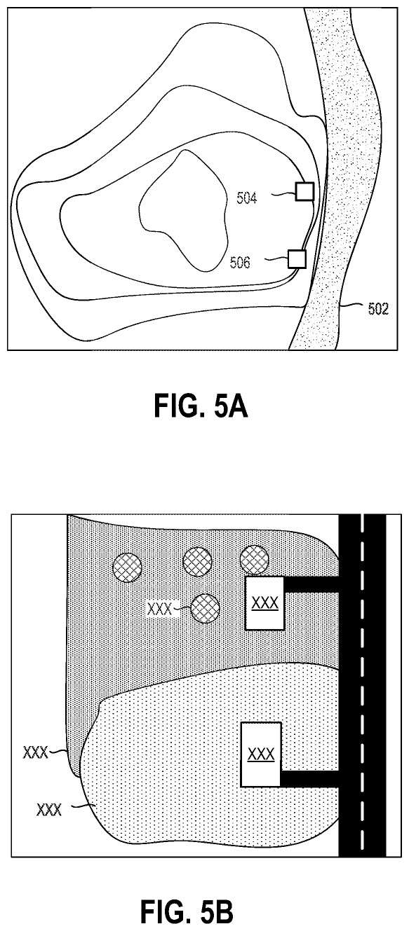

FIGS. 5A and 5B illustrate examples of micro-climate risk mitigation based on different climate risks in accordance with some aspects of the disclosure.

In one illustrative example, FIG. 5A is a topographical map showing the altitude of a geographical area having a river 502 or other water feature that is connected to a watershed or other drainage basin. In this case, because a first building 504 and a second building 506 are adjacent to the river 502, both the first building 504, and the second building 506 may have water-level risks such as flooding. In this case, the first building 504 has a foundation that is higher than the second building 506. In some cases, the climate risk assessment system may use the topographical map, satellite images, and other information to identify that the first building 504 and the second building 506 are at risk of flooding, particularly in the event that the snowfall upstream from the river 502 is higher than average, which can cause the water level of the river 502 to rise for significant portions of time.

In this case, the climate risk assessment system may be configured to identify that both the first building 504 and the second building 506 are at risk of flooding due to higher snowfall and may request the policyholders of the first building 504 and the second building 506 to take preventative measures. In this case, when a policyholder of the first building 504 does not take preventative measures, the climate risk assessment system may use the failure to take preventative action into account, such as by not renewing an insurance policy of the policyholder of the first building 504 after the term ends. On the other hand, when the second building 506 performs preventative measures, the insurer may provide incentives such as a discounted rate, a rate guarantee for a period of time, and so forth.

To this end, the climate risk assessment system can granularly identify risks on a continual basis and suggest modifications concurrently based on current events to minimize risks to buildings. The climate risk assessment system is configured to inform policyholders and other interested parties with respect to potential climate effects to strengthen properties and minimize climate change effects.

In some cases, some modifications may need to be validated. As noted above, the climate risk assessment system may be configured to perform validation based on evidence (e.g., images, invoices, etc.) submitted to the insurer. The climate risk assessment system may also retrieve information from a service that can support the validation. For example, the climate risk assessment system may recommend clearing the property of combustible materials within a minimum distance and the climate risk assessment system may validate the modification by requesting a satellite service to capture images of the property and analyzing the images (e.g., classifying the satellite images for combustible materials). In other cases, the climate risk assessment system may be configured to schedule an agent to perform several validations in person based on the complexity of the modification and the value.

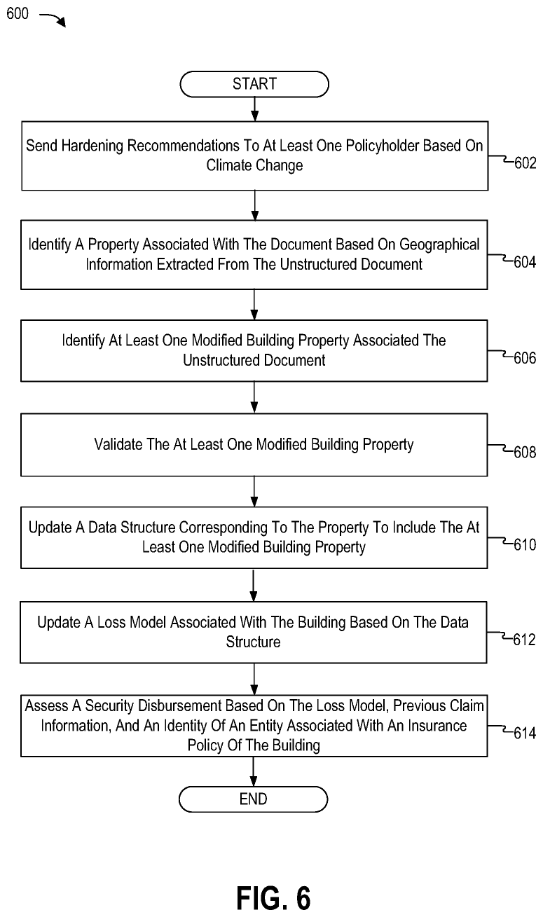

FIG. 6 illustrates an example method 600 of a climate risk assessment system in accordance with some aspects of the disclosure. The method 600 can be performed by a computing device having network communication capabilities and may be configured as a service separate from a client system or may be integrated into the client system. For instance, the computing system 1000 may be configured to perform all or part of the method 600.

Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some aspects, the computing system may generate an ML model based on a collection of unstructured data using conventional techniques such as unstructured information stored by an insurer, purchasing a commercial database, scraping the information off public resources, obtaining access to repositories, and so forth. Non-limiting examples of unstructured data are described above and relate to various information that can be used for climate risk assessment. In addition, the ML model can be generated based on structured information, supervised training, and other techniques described above. In one illustrative example, the computing system may receive a plurality of documents, with each document is associated with a specific building (e.g., insurance information), receive a plurality of unstructured documents, with at least a portion of the unstructured documents correspond to a building in the plurality of documents (e.g., MLS information, etc.), and map historical data pertaining to building lifecycle to each building in the plurality of documents. For example, as shown above in FIG. 3, a model can be constructed that represents the lifecycle of a building. Based on the various models, the computing system may train an ML model for estimating a loss associated with each building in the plurality of documents.

In some cases, the ML model can be trained based on supervised processes, such as a data model having rule-based logic associated with a third party to boost and tune training. In one aspect, the data model is associated with a building standards association and identifies at least one of hardening standards, damage classifications, damage assessments, and weather assessments.

At block 602, the computing system may send hardening recommendations to at least one policyholder based on climate change. In one illustrative example of block 602, the computing system may identify at least one improvement based on the geographical information corresponding to decreased risk associated with at least one ascending risk, and the ascending risk is highly correlated to the geographical information. Based on identifying the improvement, the computing system may generate educational information corresponding to the at least one improvement and send the education information to an entity associated with the building. In some cases, the education information can also include incentives, which can be determined by the ML model or may be determined by a supervised process.

At block 604, the computing system may receive an unstructured document from the policyholder or another party and may identify a property associated with the document based on geographical information extracted from the unstructured document.

At block 606, the computing system may identify at least one modified building property associated with the unstructured document. As noted above, the at least one modified building property is associated with at least one ascending risk associated with increased carbon dioxide present in the atmosphere. The modified building property may vary based on the region and specific weather effects that increased carbon dioxide can and will have on the region (e.g., increased rainfall, stronger hurricanes, etc.).

At block 608, the computing system may be configured to validate at least one modified building property. In some cases, the computing system may autonomously validate the modified building property based on evidence submitted (e.g., images). As an example, at block 608, the computing system may receive supporting evidence corresponding to the at least one modified building property, process the supporting evidence, and determine whether the supporting evidence supports the at least one modified building property. In some cases, the computing system may require external validation. For example, the computing system may determine that, when the supporting evidence does not support the at least one modified building property, an in-persona inspection is required. In some cases, to streamline inspection, the computing system may pool validations based on geography to reduce time consumed by an agent to inspect different properties (e.g., reduce travel time between properties). For example, the computing system may, in response to receiving a claim or an event that requires an agent to be present at the building, generate a list of building properties to inspect in connection with an increased risk of climate damage. For example, the list of buildings can be proximate to a primary building, and agent can validate various modifications of other properties and buildings.

At block 610, the computing system may update a data structure corresponding to the property to include the at least one modified building property. In some aspects, the data structure comprises an immutable data structure that can only be appended to. For example, the data structure can include cryptographic hashes that validate data appended and may be referred to as a blockchain, distributed ledger, and so forth.

At block 612, the computing system may update a loss model associated with the building based on the data structure. In some cases, the loss model can be generated by ML model based on the changes applied to the building. In other cases, the loss model can be updated based on a declarative, rule-based approach.

At block 614, the computing system may assess a security disbursement based on the loss model, previous claims corresponding to the building, previous claims corresponding to related buildings, and an identity of an entity associated with an insurance policy of the building. For example, the security disbursement may be an insurance premium that the policyholder may need to pay on a continual basis to insure the property.

FIG. 7 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 700 reduces the operations of learning dependencies by using an encoder 710 and a decoder 730 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 710 is composed of a stack of six identical layers and each layer has two sub-layers. The first sub-layer is a multi-head self-attention engine 712, and the second sub-layer is a fully connected feed-forward network 714. A residual connection (not shown) connects around each of the sub-layers followed by normalization.

In this example transformer 700, the decoder 730 is also composed of a stack of six 6 identical layers. The decoder also includes a masked multi-head self-attention engine 732, a multi-head attention engine 734 over the output of the encoder 710, and a fully connected feed-forward network 736. Each layer includes a residual connection (not shown) around the layer, which is followed by layer normalization. The masked multi-head self-attention engine 732 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 740 to encode positions because the model does not contain recurrence and convolution and relative or absolute position of the tokens is needed. In the transformer 700, the positional encodings are added to the input embeddings at the bottom layer of the encoder 710 and the decoder 730. The positional encodings are summed with the embeddings because the positional encodings and embeddings have the same dimensions. A corresponding position decoder 750 is configured to decode the positions of the embeddings for the decoder 730.

In some aspects, the transformer 700 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 700 can process input sequences of variable length, making it well-suited for natural language processing tasks where input lengths can vary greatly. Additionally, the self-attention mechanism allows the transformer 700 to capture long-range dependencies between words in the input sequence, which is difficult for recurrent neural networks (RNNs) and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

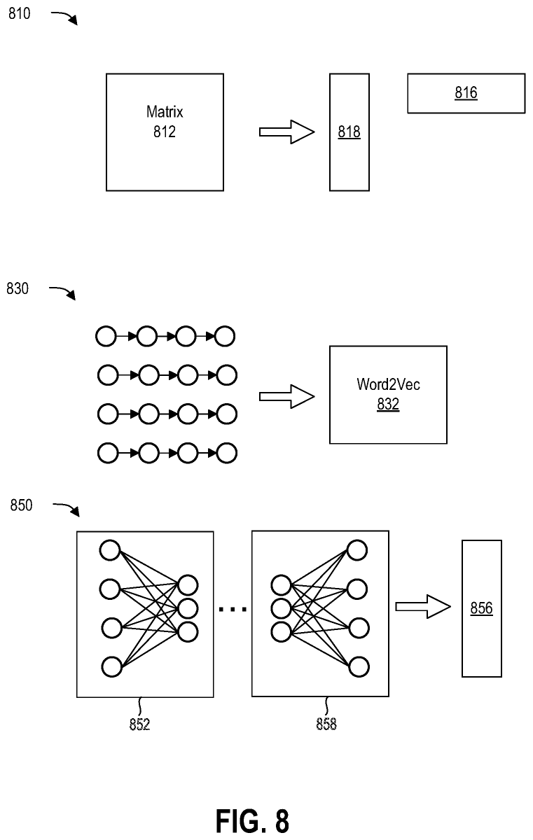

FIG. 8 is a block diagram of various encoders that can be used to identify features of unstructured documents in accordance with some aspects of the disclosure. In particular, FIG. 8 includes a block diagram of a matrix encoder 810, a random walk encoder 830, and a neural network encoder 850.

The matrix encoder 810 identifies the most important features of data (e.g., most important embeddings) and reduces the features into a lower dimensional representation. Non-limiting examples of techniques incorporated into the matrix encoder 810 include singular value decomposition (SVD), principal component analysis (PCA), or autoencoders to perform the transformation. For example, the matrix encoder 810 converts a matrix 812 into a column 814 of components and a row 816 of features associated with the components. The lower-dimension representation of the matrix 812 can be used to assist in clustering, classification, and visualization, as well as improve the efficiency of computations.

The random walk encoder 830 simulates a random walk process on graphs or networks to generate sequences of node visits that are used as input into a neural network, such as word2vec 832 to produce a word embedding. The random walk process involves starting at a randomly chosen node in the graph and moving to a neighboring node at each step according to a certain probability distribution. By repeating this process for multiple iterations, a sequence of node visits is generated for each starting node. These sequences are then used as the input data.

The neural network encoder 850 is a trained neural network that has learned mappings between a high-dimensional input into a lower-dimensional space. The neural network encoder 850 includes an encoder and may include a decoder. Each encoder of the neural network encoder 850 includes several layers of artificial neurons that perform a non-linear transformation on the input data and reduce high-dimensional data to lower data by learning based on various techniques, such as backpropagation. The neural network encoder can be trained using various optimization techniques to minimize a loss function that measures the difference between the original high-dimensional data and the reconstructed data. The neural network encoder 850 provides flexibility and ability to learn complex and non-linear mappings between the input data and the encoding result but requires large amounts of training data, computational resources, and careful tuning of the network architecture and hyperparameters.

The matrix encoder 810, the random walk encoder 830, and the neural network encoder 850 each have advantages and disadvantages. The matrix encoder 810 is computationally efficient and can handle large datasets but may not be as effective in capturing semantic information or feature interactions. The random walk encoder 830 is effective in capturing structural information and node similarities in graphs but may not be suitable for other types of data. The neural network encoder 850 is flexible and can learn complex mappings between the input data and the encoding but may require large amounts of training data and computational resources.

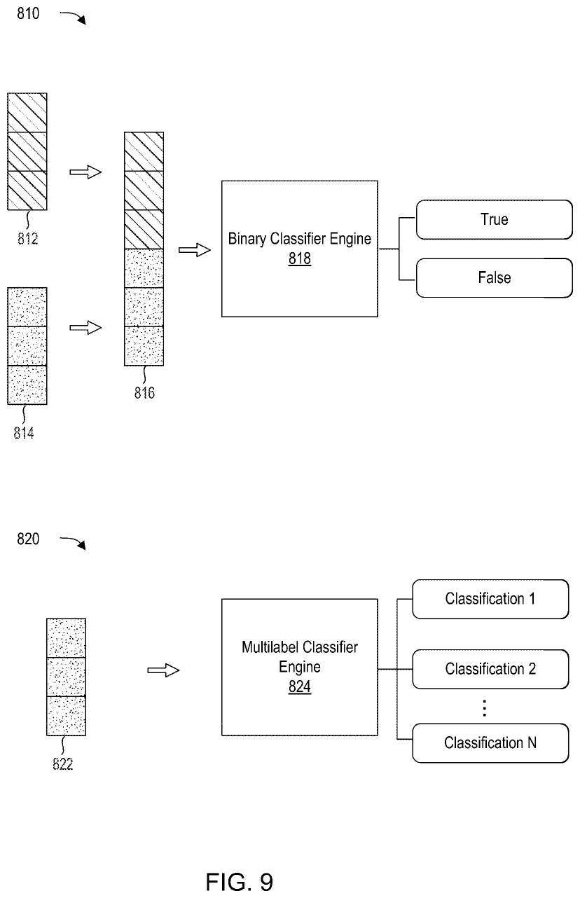

FIG. 9 is a block diagram of various classifiers that can be used to identify one or more classifications from one or more taxonomies in accordance with some aspects of the disclosure. In particular, FIG. 9 includes a binary classifier 910 and a multilabel classifier 950.

The binary classifier 910 is configured to classify data into two categories that is generally represented by true or false. An example of a binary classification includes a classification of an email as spam or not spam. Other examples of binary classification include sentiment analysis (e.g., positive review or negative review) and fraud detection.

One example of a binary classifier includes concatenating a first embedding 912 and a second embedding 914 into a summed embedding 916 and then executing a binary classifier engine 918, which determines whether the summed embedding 916 corresponds to a characteristic that the binary classifier engine 918 is trained to detect.

A multilabel classifier 920 is configured to classify data into multiple categories or labels, where each example may belong to more than one label. The classifier is trained using a labeled dataset, where each example is associated with a set of binary labels. The classifier then learns a decision boundary for each label in the input space. An example of a multilabel classifier includes a color classification (e.g., red, green, etc.), a music genre classification, a car type, etc. The multilabel classifier 920 is effective in capturing the complex relationships and dependencies among the labels, as well as handling imbalanced and overlapping label distributions.

An example of a binary classifier includes inputting an embedding 922 into a multilabel classifier engine 924, which analyzes the embedding based on trained data to identify the corresponding classification (e.g., color, type, etc.).

In some aspects, the binary classifier 910 and the multilabel classifier 920 can be implemented at various points of the climate risk assessment system 200 and may be used to determine the clustering of various embeddings, such as damage classifications, weather classification, etc.

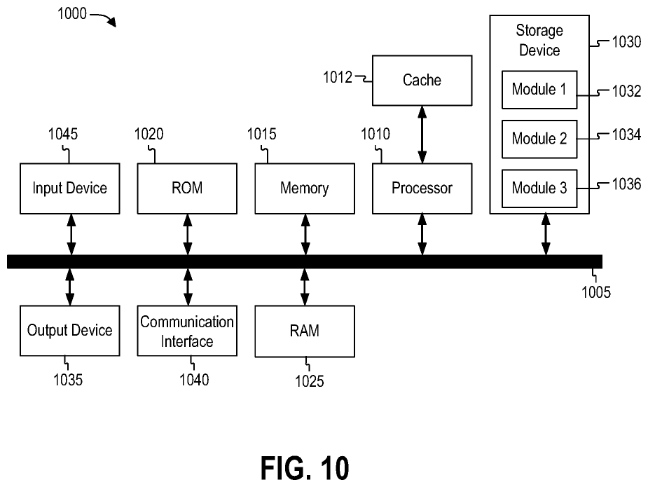

FIG. 10 is a diagram illustrating an example of a system for implementing certain aspects of the present technology. In particular, FIG. 10 illustrates an example of computing system 1000, which can be for example any computing device making up an internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1000 includes at least one processing unit (CPU or processor) 1010 and connection 1005 that couples various system components including system memory 1015, such as ROM 1020 and RAM 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices, or other small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random-access memory (SDRAM), ROM, non-volatile random-access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method comprising:
receiving an unstructured document;
identifying a property associated with the document based on geographical information extracted from the unstructured document;
identifying at least one modified building property associated with the unstructured document;
updating a data structure corresponding to the property to include the at least one modified building property; and
updating a loss model associated with the property based on the data structure.

2. The method of claim 1, wherein the at least one modified building property is associated with at least one ascending risk associated with increased carbon dioxide presence in the atmosphere.

3. The method of claim 1, further comprising:
identifying at least one improvement based on the geographical information corresponding to decreased risk associated with at least one ascending risk, wherein the ascending risk is correlated to the geographical information;
generating educational information corresponding to the at least one improvement; and
sending the education information to an entity associated with the property.

4. The method of claim 3, further comprising:
identifying whether a second unstructured document is associated with a change identified in the education information;
updating the loss model associated with at least one improvement identified in the second unstructured document; and
updating a model of the entity associated with the property.

5. The method of claim 1, further comprising:
assessing a security requirement based on the loss model, previous claims corresponding to the property, previous claims corresponding to related properties, and an identity of an entity associated with a policy of the property.

6. The method of claim 1, further comprising:
receiving supporting evidence corresponding to the at least one modified building property;
processing the supporting evidence and determining whether the supporting evidence supports the at least one modified building property; and
when the supporting evidence does not support the at least one modified building property, determining whether an in-person inspection is required.

7. The method of claim 1, wherein data structure comprises an immutable data structure that can only be appended to.

8. The method of claim 1, further comprising:
receiving a plurality of documents associated with at least one specific property;
receiving a plurality of unstructured documents, wherein at least a portion of the unstructured documents corresponds to the at least one specific property;
mapping historical data pertaining to building lifecycle to the at least one specific property in the plurality of documents; and
training a machine learning model for estimating a property loss based on the mapped historical data.

9. The method of claim 8, wherein the machine learning model is further trained by a data model generated by a third party.

10. The method of claim 9, wherein the data model is associated with a building standards association, and wherein the data model identifies at least one of hardening standards, damage classifications, damage assessments, or weather assessments.

11. The method of claim 1, further comprising:
in response to receiving an event that requires an agent to be present at the building, generating a list of building properties to inspect in connection with an increased risk of climate damage.

12. A system comprising:
a storage configured to store instructions;
at least one processor configured to execute the instructions to cause the at least one processor to:
receive an unstructured document;
identify a property associated with the document based on geographical information extracted from the unstructured document;
identify at least one modified building property associated the unstructured document;
update a data structure corresponding to the property to include the at least one modified building property; and
update a loss model associated with the property based on the data structure.

13. The system of claim 12, wherein the at least one modified building property is associated with at least one ascending risk associated with increased carbon dioxide presence in the atmosphere.

14. The system of claim 12, wherein the instructions further cause the at least one processor to:
identify at least one improvement based on the geographical information corresponding to decreased risk associated with at least one ascending risk, wherein the ascending risk is correlated to the geographical information;
generate educational information corresponding to the at least one improvement; and
send the education information to an entity associated with the property.

15. The system of claim 14, wherein the instructions further cause the at least one processor to:
identify whether a second unstructured document is associated with a change identified in the education information;
update the loss model associated with at least one improvement identified in the second unstructured document; and
update a model of the entity associated with the property.

16. The system of claim 12, wherein the instructions further cause the at least one processor to:
assess a security requirement based on the loss model, previous claims corresponding to the property, previous claims corresponding to related properties, and an identity of an entity associated with a policy of the property.

17. The system of claim 12, wherein the instructions further cause the at least one processor to:
receive supporting evidence corresponding to the at least one modified building property;
process the supporting evidence and determining whether the supporting evidence supports the at least one modified building property; and
when the supporting evidence does not support the at least one modified building property, determine whether an in-person inspection is required.

18. The system of claim 12, wherein data structure comprises an immutable data structure that can only be appended to.

19. The system of claim 12, wherein the instructions further cause the at least one processor to:
receive a plurality of documents associated with at least one specific property;
receive a plurality of unstructured documents, wherein at least a portion of the unstructured documents corresponds to the at least one specific property;
map historical data pertaining to building lifecycle to the at least one specific property in the plurality of documents; and
train a machine learning model for estimating a property loss based on the mapped historical data.

20. The system of claim 12, wherein the machine learning model is further trained by a data model generated by a third party, and wherein the data model is associated with a building standards association, and wherein the data model identifies at least one of hardening standards, damage classifications, damage assessments, or weather assessments.
